(19) United States
(12) Patent Application Publication
(10) Pub. No.: US 2006/0126522 A1
(43) Pub. Date: Jun. 15, 2006

(54) Detecting malicious codes

(76) Inventor: Du-Young Oh, Bucheon-si (KR)

Correspondence Address: Robert E. Bushnell;Suite 300, 1522 K Street, N.W., Washington, DC, 20005-1202, US

(21) Appl. No.: 11/267,295

(22) Filed: Nov. 7, 2005

(30) Foreign Application Priority Data
Nov. 8, 2004 (KR) 2004-90605

(51) Int. Cl. H04J 1/16; H04L 12/56

(52) U.S. Cl. 370/250; 370/389; 370/252

(57) ABSTRACT

A malicious code detection method includes: registering information on an incoming TCP connection setup packet to an internal network and storing contents of a TCP data packet for the registered connection; storing data for the corresponding TCP connection upon a connection determined to request a traffic connection of the same feature as the incoming TCP traffic within a predetermined time during a TCP connection setup being directed to an external network; and determining a data packet to be malicious code upon a determination that the data packet of the outgoing TCP traffic is the same as the registered incoming TCP traffic data packet.

### CLAIM OF PRIORITY

This application makes reference to, incorporates the same herein, and claims all benefits accruing under 35 U.S.C. §119 from an application for METHOD AND APPARATUS FOR DETECTING MALICIOUS CODES earlier filed in the Korean Intellectual Property Office on 8 NOV. 2004 and there duly assigned Serial No. 2004-90605.

### BACKGROUND OF THE INVENTION

1. Field of the Invention

The present invention relates to malicious code detection and, more particularly, to a method and apparatus to detect malicious codes, in which unknown Internet worms are detected as soon as possible by observing packet movements on a network and preventing the spread of Internet worms by reporting their detection.

2. Description of the Related Art

As Internet technology develops, Internet threat factors are increasing. Typical threat factors include malicious codes, and the malicious codes can be generally divided in theoretical definition and substantial definition. The theoretical definition includes all computer programs or executable portions that are devised for the purpose of damaging other people, and the substantial definition includes computer programs or executable portions that are devised for the purpose of injuring other people psychologically or substantially. Bugs included due to a programmer's fault are excluded in the malicious codes, but these bugs are included in the malicious codes if they are expected to cause an enormous amount of damage.

Typical examples of the malicious codes include computer viruses and Internet worms.

A computer virus is a form of program, which infects an infection target program to be executed with its own code and a translated code and is spread in a network and a computer system when an infected file is executed.

An Internet worm exists in a form of process, which infects in a method of operating a worm process in other hosts on a network. Since the infection of an Internet worm does not need a human operation and lots of traffic are generated to infect the Internet worm, it is also not possible for a host that is not infected to make use of the Internet and it causes an Internet disturbance. Starting with the Morris Worm that was widely spread and caused damage to the Internet service in 1988, many worms have been generated to cause much damage.

An Internet worm has a feature that it propagates by itself through the network, which is different from the existing computer viruses. While a computer virus causes damage by deleting and modifying normal files, an Internet worm causes damage by draining network resources and disturbing a normal network service due to its explosive spreading property.

Accordingly, domestic and oversea companies have introduced anti-virus products. In most cases, such products have databases (DBs) storing patterns of known computer viruses and worms and detect a virus threat by using a pattern matching technique where a determination is made as to whether a suspected file and process are matched with the stored patterns.

The known anti-virus products were embodied in a method where a pattern database is constructed by collecting a series of specific character strings (patterns) of a program with respect to known viruses, and they can be effective defensive measures against the known viruses. However, the anti-virus products are defenseless against unknown viruses or worms, and their main objectives are to protect a host and an inner network so that there is a disadvantage in that consumption of network resources by attack traffic cannot be prevented.

As described above, the anti-virus products using the pattern matching technique employing the known pattern DB can be used to detect known computer viruses and Internet worms but they cannot be effectively applied to detect unknown Internet worms.

Also, such anti-virus products are generally positioned in a terminal and their principal objectives are to protect the corresponding terminal against a dangerous threat. In the case of using such a method, it is not possible to prevent the attack packet from transmitting to the corresponding terminal through a network so that network resources are still consumed.

### SUMMARY OF THE INVENTION

It is, therefore, an object of the present invention to provide an apparatus and method to detect malicious codes, wherein TCP packets passing through a bottleneck of a network are inspected using a detection apparatus installed in the bottleneck of the network to determine whether an outgoing packet has been generated by an Internet worm and to minimize the consumption of network resources caused by the Internet worm by generating an alarm and intercepting the corresponding packet.

According to an aspect of the present invention, a method is provided comprising: registering information on an incoming TCP connection setup packet to an internal network and storing contents of a TCP data packet for the registered connection; storing data for the corresponding TCP connection upon a connection determined to request a traffic connection of the same feature as the incoming TCP traffic within a predetermined time during a TCP connection setup being directed to an external network; and determining a data packet to be malicious code upon a determination that the data packet of the outgoing TCP traffic is the same as the registered incoming TCP traffic data packet. The incoming TCP traffic is preferably stored in an incoming TCP connection table and the outgoing TCP traffic is stored in an outgoing TCP connection table.

The incoming TCP connection table preferably comprises at least one entry including a source IP address, a destination IP address, a source TCP port number, a destination TCP port number, an entry registration time, and at least one data packet storage space.

The outgoing TCP connection table preferably comprises at least one entry including a source IP address, a destination IP address, a source TCP port number, a destination TCP port number, an entry registration time, and at least one data packet storage space.

Registering information on an incoming TCP connection setup packet to an internal network and storing contents of a TCP data packet for the registered connection preferably comprises registering the corresponding traffic with the incoming TCP connection data upon the corresponding packet not being registered in the incoming TCP connection data and the incoming traffic being a TCP SYN packet.

Information on a source IP address, a destination IP address, a source TCP port, and a destination TCP port among header information of the incoming traffic TCP SYN packet is preferably registered in the same item of the incoming TCP connection table; an entry registration time is the time when the TCP SYN packet is registered; and no data is registered in a data storage space of the incoming TCP connection table.

Registering information on an incoming TCP connection setup packet to an internal network and storing contents of a TCP data packet for the registered connection preferably further comprises: comparing header information of the corresponding packet with the same item of each entry of the incoming TCP connection table and determining whether the corresponding traffic is registered in the incoming TCP connection table upon the incoming traffic being a TCP data packet; and registering pure data information of the incoming TCP data packet in a data packet field of the corresponding entry upon an entry identical to the incoming TCP data packet being found as a result of the determination.

The data packet field preferably comprises at least one storage space having a maximum value that is changeable by an operator.

Comparing header information of the corresponding packet with the same item of each entry of the incoming TCP connection table and determining whether the corresponding traffic is registered in the incoming TCP connection table upon the incoming traffic being a TCP data packet preferably comprises: comparing information on a source IP address, a destination IP address, a source TCP port, and a destination TCP port, and determining the information on the header of the incoming TCP data packet and the information on the incoming TCP connection table to be identical only when all of the comparison items are the same.

Storing data for the corresponding TCP connection upon a connection determined to request a traffic connection of the same feature as the incoming TCP traffic within a predetermined time during a TCP connection setup being directed to an external network preferably comprises registering information on the TCP SYN packet in an outgoing connection table upon information on the corresponding packet being compared with each entry registered in the incoming TCP connection table and an entry including the same information and the outgoing traffic being a TCP SYN packet.

Determining that TCP SYN packet information and TCP connection table entry information are the same traffic preferably comprises: determining that a source IP address of the TCP SYN packet and a destination IP address of the incoming TCP connection table entry are the same, and a destination TCP port number of the TCP SYN packet and a destination TCP port number of the TCP connection table entry are the same.

Storing data for the corresponding TCP connection upon a connection determined to request a traffic connection of the same feature as the incoming TCP traffic within a predetermined time during a TCP connection setup being directed to an external network preferably further comprises: comparing a header of the corresponding packet and each entry information of the outgoing TCP connection table upon the outgoing traffic being a TCP data packet; comparing contents of pure data of the outgoing TCP data packet with contents of a data packet stored in a data storage space of the corresponding entry upon a determination that entry information is the same traffic as the outgoing TCP data packet; and determining the outgoing TCP traffic to be generated by a malicious code upon a determination that the two data are identical as a result of the packet comparison. Each entry of the incoming TCP table or the incoming TCP table is preferably deleted from the corresponding table after the passage of a predetermined time period from an entry registration time.

Information stored in the data packet storage space preferably comprises a checksum value of transmitted pure data.

Information stored in the data packet storage space preferably comprises a checksum value of transmitted pure data.

According to another aspect of the present invention, a method is provided comprising: registering an incoming UDP connection to an internal network and storing contents of a UDP data packet for the registered connection; determining that an internal host, connected to outside by a connection request received from outside, has requested a connection to the same destination UDP port within a predetermined time, among the UDP connections directed to an external network from the internal network and an outgoing UDP traffic registration to store data for the corresponding UDP connection; and determining that a packet is malicious code upon a determination that the outgoing UDP connection data packet and the packet registered with the incoming connection data are the same. Registering and storing UDP data preferably comprises generating a UDP table entry and storing the corresponding data packet upon the same data packet having not been received within a session timeout time period of a previous UDP session for a specific data packet.

According to another aspect of the present invention, an apparatus is provided comprising: a database including an outgoing TCP connection table adapted to register incoming TCP packet setup packet information to an internal network, and to store data for the corresponding TCP connection upon an incoming TCP connection table storing contents of a TCP data packet for the registered connection and a TCP connection directed to an external network from the internal network receiving a connection request from outside and an internal host connected to the outside requesting a connection to the same destination TCP port within a predetermined time period; and a controller connected to the incoming and outgoing TCP connection tables and adapted to register, compare and store data and to determine a data packet to be malicious code upon a data packet of the outgoing TCP traffic being the same as the registered incoming TCP traffic data packet.

The apparatus is preferably arranged in a bottleneck between the internal network and an external Internet network.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a propagation diagram of an Internet worm;

FIG. 2 is a view of a position where an apparatus to detect malicious codes in accordance with an embodiment of the present invention is placed on a network;

FIG. 3 is a TCP connection table in accordance with an embodiment of the present invention;

FIG. 4 is a TCP connection table using a checksum;

FIG. 5 is a flowchart of a method of detecting malicious codes in accordance with an embodiment of the present invention;

FIG. 6 is a flowchart of a packet separation procedure of an apparatus to detect malicious codes in accordance with an embodiment of the present invention;

FIG. 7 is a flowchart of a method of processing an incoming TCP SYN packet;

FIG. 8 is a flowchart of a method of processing an incoming TCP data packet;

FIG. 9 is a flowchart of a method of processing an outgoing TCP SYN packet; and

FIG. 10 is a flowchart of a method of processing an outgoing TCP data packet.

### DETAILED DESCRIPTION OF THE INVENTION

The present invention will now be described more fully hereinafter with reference to the accompanying drawings, in which exemplary embodiments of the present invention are shown. The present invention can, however, be embodied in different forms and should not be construed as being limited to the embodiments set forth herein. Rather, these embodiments are provided so that this disclosure will be thorough and complete, and will fully convey the scope of the present invention to those skilled in the art. In the drawings, like numbers refer to like elements throughout the specification.

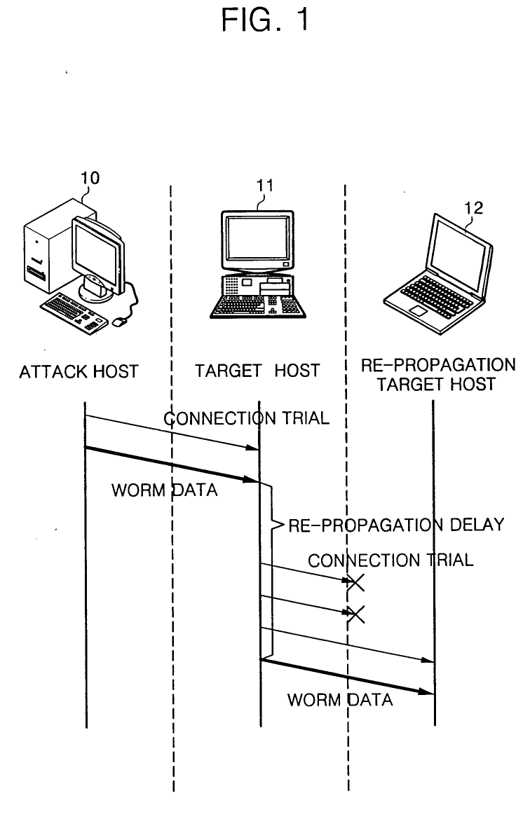

FIG. 1 is a propagation diagram of an Internet worm.

In the propagation of an Internet worm, when a target host 11 is infected by an attack host 10, the target host 11 becomes a main subject that infects other hosts. That is called ‘re-propagation’, and a ‘re-propagation delay’ in the target host is the time period that has elapsed from a infection time of the target host to a first re-propagation trial time by the target host.

Vertical lines indicate time axes, which are formed on the basis of each of the hosts in FIG. 1, and each of the arrows indicates a connection trial. ‘X’ indicates that an infection trial with respect to the target host has failed due to the fact that there is no target IP.

FIG. 1 can be explained on the basis of a propagation path of the Internet worm that is performing using a TCP protocol, in which the connection trial (through an SYN packet) by the attack host 10 is indicated by a thin arrow, and the transmission of worm data after the connection has succeeded is indicated by a thick arrow.

In the propagation of the Internet worm, the re-propagation time by the target host 11 is very short, that is, the target host infects other hosts within 1 second. Also, it is remarkable that a TCP port number used in the process of infection and re-propagation is always the same.

The features of the worm traffic reviewed with reference to FIG. 1 are as follows.

First, a trend of incoming traffic appears in an early stage of infection, wherein the traffic travels from outside to inside.

Second, the re-propagation time to other hosts is very short (within 1 second).

Third, the worm data is duplicated (A target port is equally maintained in the case of the TCP protocol).

An apparatus for detecting malicious codes in accordance with the present invention embodies an effective worm traffic apparatus and method using the features of worm traffic described above.

The apparatus for detecting malicious codes in accordance with the present invention is arranged in a bottleneck of a network for the purpose of detecting incoming and outgoing traffic from the network. The bottleneck of the network refers to a link through which all incoming packets generated outside of the network and directed inside of the network pass and through which all outgoing packets generated inside the network and directed outside of the network pass. An access router or the like can be arranged in such a place.

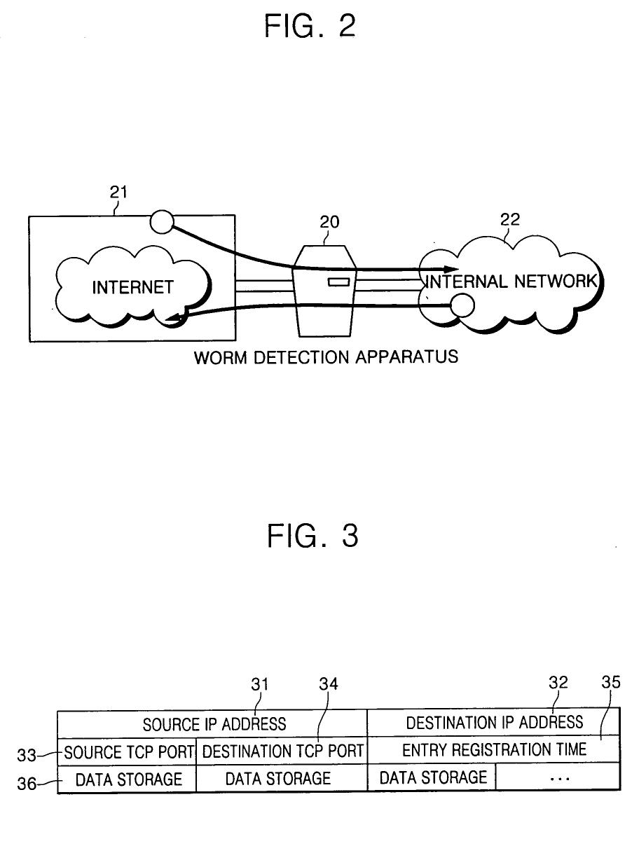

FIG. 2 is a view of a position where an apparatus to detect malicious codes in accordance with an embodiment of the present invention is placed on a network.

As shown in FIG. 2, the malicious code detection apparatus 20 in accordance with the present invention is positioned in a bottleneck between the Internet and an internal network so that it can monitor incoming traffic from the external network to the internal network and outgoing traffic from the internal network to the external network and detect malicious codes.

As such, the malicious code detection apparatus 20 in accordance with the present invention includes a database and a controller, wherein the database includes an incoming TCP connection table and an outgoing TCP connection table.

The incoming TCP connection table registers an incoming TCP connection to the internal network and stores the contents of a TCP data packet with respect to the registered connection. The outgoing TCP connection table stores data for the TCP connection when the TCP connection directed to the external network from the internal network has received a connection request from the outside and has determined that an internal host that has been connected to the outside has requested a connection to the same destination TCP port within a predetermined time period.

The controller is connected to the incoming and outgoing TCP connection tables to take charge of registering, comparing and storing various kinds of data. When the same packet as the data packet of the outgoing TCP traffic is stored as data of the incoming TCP traffic, the controller determines the corresponding packet to be worm traffic and takes appropriate measures.

FIG. 3 is a TCP connection table in accordance with an embodiment of the present invention.

The malicious code detection apparatus 20 in accordance with an embodiment of the present invention has an incoming TCP connection table and an outgoing TCP connection table, and one entry of each table includes information on a source IP address 31, a target IP address 32, a source TCP port number 33, a destination TCP port number 34, a packet storage space 36 for the maximum number of data packets (MAX_DATA_PACKET), and an entry registration time.

Both the incoming TCP connection table and the outgoing TCP connection table are constructed in the same form as shown in FIG. 3, and play important roles in detecting malicious codes.

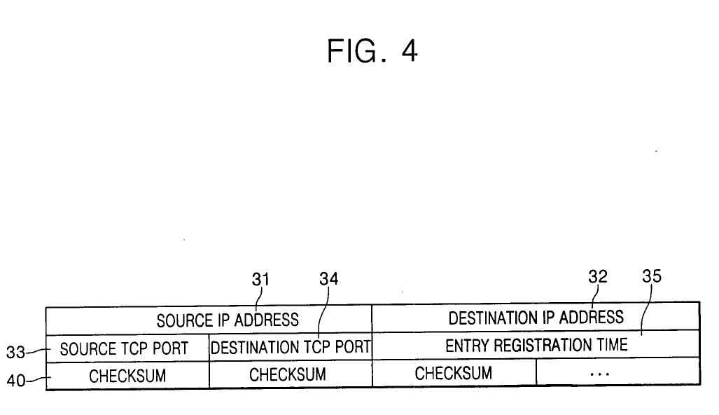

FIG. 4 is a TCP connection table using a checksum.

The table in FIG. 4 is different from that of FIG. 3 in that the data storage space does not actually store data to be transmitted through the TCP packet but rather stores a checksum value of corresponding data.

The checksum used in the embodiment of FIG. 4 is a checksum for pure data excluding a packet header portion in the TCP checksum.

The TCP checksum can be obtained by summing a temporary IP header, a TCP header and a one's complement. The TCP header includes a port number of a transmitter, a destination port number, an order number for transmission, a response confirmation number, a header length, a code bit, a window, a checksum, an urgent pointer, and so on.

Accordingly, if a one's compliment of a content of the temporary IP header plus the TCP header is subtracted from a value included in the checksum item of the TCP header, the sum of the one's compliment of the corresponding data can be obtained.

If the checksum value obtained as described above is stored instead of storing all of the data as in FIG. 3, it is possible to store information on the corresponding data and it also becomes very simple to compare with and search for other packets with a space of 4 bytes per packet.

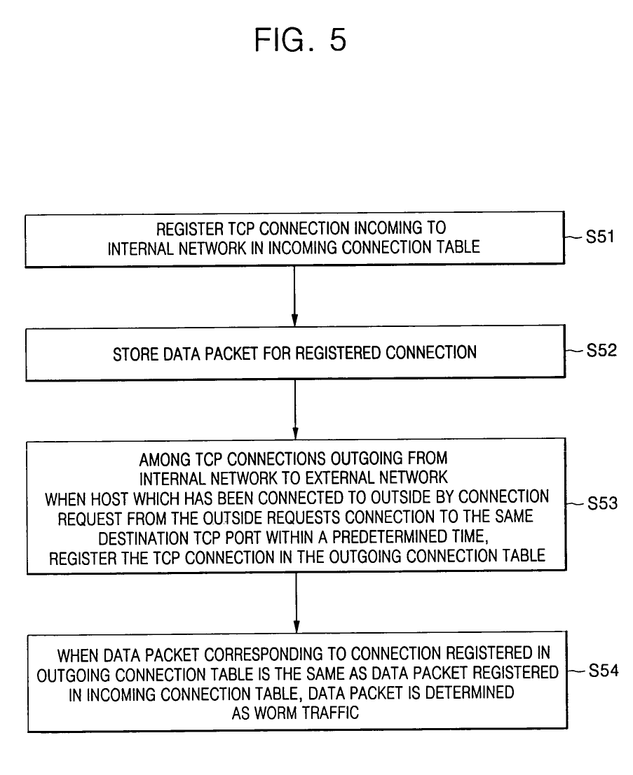

FIG. 5 is a flowchart of a method of detecting malicious codes in accordance with an embodiment of the present invention.

According to the malicious code detection method, incoming TCP connections to various kinds of internal networks are registered in an incoming connection table (S51). A data packet for the registered connection is stored (S52). When a host, which has been connected to the outside by a connection request from the outside among the outgoing TCP connections from the internal network to the external network, requests a connection to the same destination TCP port within a predetermined time, it is registered in the outgoing connection table (S53).

When the data packet corresponding to the connection registered in the outgoing connection table is monitored and the same packet exists among the data packets registered in the incoming connection table, the data packet is determined to be worm traffic (S54) so that an alarm message is sent to a network manager or the traffic determined to be worm traffic is discarded.

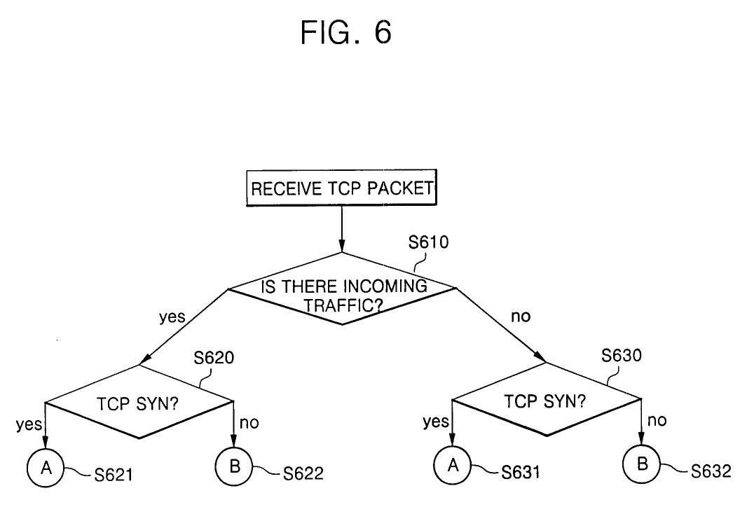

FIG. 6 is a flowchart of a packet separation procedure of an apparatus to detect malicious codes in accordance with an embodiment of the present invention.

When the malicious code detection apparatus 20 receives a TCP packet, a determination is made as to whether the packet is incoming traffic directed toward an external Internet network or the like from an internal network or is outgoing traffic directed toward the internal network from the external network (S610).

After determining the direction of the traffic, the incoming traffic and the outgoing traffic is classified as a TCP SYN packet or a TCP data packet (S620 and S630).

In FIG. 6, an ‘A’ procedure is performed for an incoming TCP SYN packet (S621), a ‘B’ procedure is performed for an incoming TCP data packet (S622), a ‘C’ procedure is performed for an outgoing TCP SYN packet (S631), and a ‘D’ procedure is performed for an outgoing TCP data packet (S632).

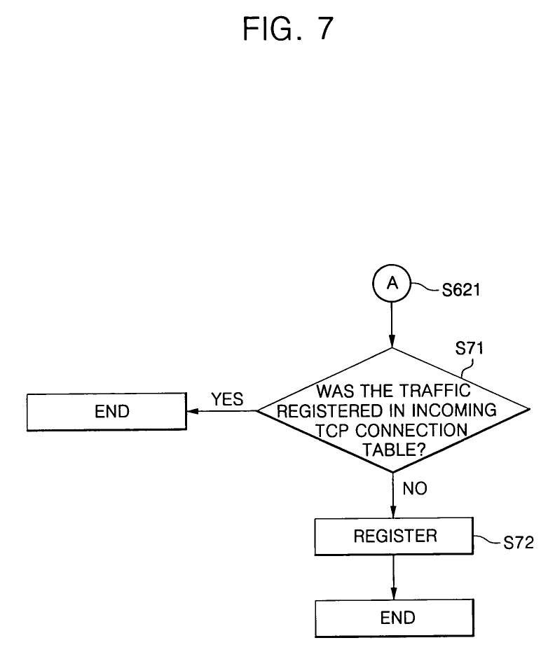

Details for each procedure are described with reference to FIGS. 7 to 10. FIGS. 7 to 10 are flowcharts of processing procedures or methods according to each kind of packet separated through the procedures of FIG. 6.

FIG. 7 is a flowchart of a method of processing an incoming TCP SYN packet.

When detected traffic is an incoming TCP SYN packet, the malicious code detection apparatus 20 in accordance with an embodiment of the present invention first determines whether or not the packet has been registered in an incoming TCP connection table (S71). When the packet has been registered, the procedure is terminated since it is not necessary to register the same traffic again. However, when the packet has not been registered, the corresponding traffic is registered in the incoming TCP connection table since the detected traffic is new traffic (S72).

The source IP address 31, the destination IP address 32, the source TCP port 33 and the destination TCP port 34 among entries of the TCP connection table reviewed in FIG. 3 register information are included in the TCP header of the SYN packet in the corresponding item. Since the data packet storage space set by the number of MAX_DATA_PACKET is a pure space for storing data, the SYN packet does not need to be registered. The entry is registered at the time of registering the TCP SYN packet.

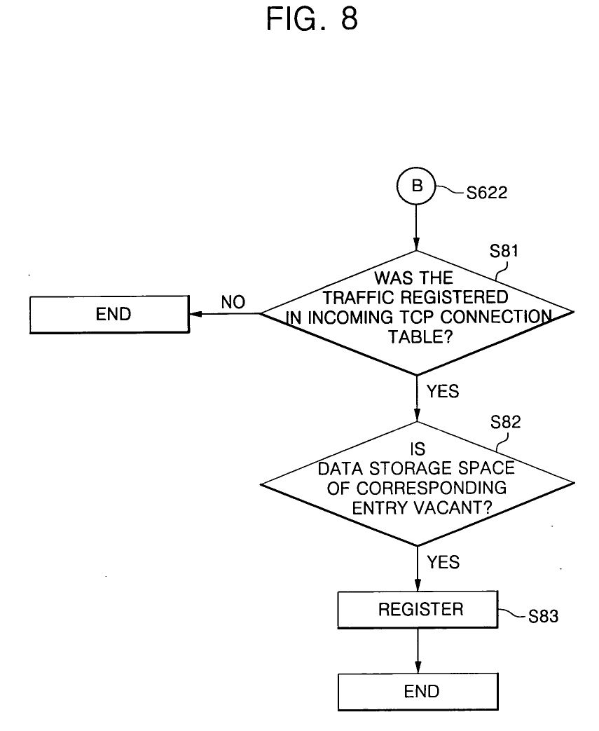

FIG. 8 is a flowchart of a method of processing an incoming TCP data packet.

Although FIG. 8 shows a processing order of the case where the incoming traffic is detected as in FIG. 7, it is a procedure followed when it is assumed that the traffic is not a SYN packet but rather is a data packet. The incoming TCP data packet includes all packets that are not the SYN packet among the incoming TCP packets.

When the malicious code detection apparatus 20 detects the incoming TCP data packet, header information of the corresponding data packet is compared with each item of the incoming TCP connection table, and a determination is made as to whether or not the corresponding traffic has been registered in the incoming TCP connection table (S81).

The header information of the data packet is compared with the source IP address, the destination IP address, the source TCP port and the destination TCP port of each entry of the incoming TCP connection table so as to find an entry in which all of its items are matched. If such an entry exists and the data packet storage space of the entry is not full (S82), pure data information of the data packet is registered in a data packet storage space of the corresponding entry that is vacant (S83).

The data packet storage space is set by the maximum number of MAX_DATA_PACKETs, which can be changed by an operator. For reference, the MAX_DATA_PACKET is set to 5 in the simulation for a malicious code detection method in accordance with an embodiment of the present invention.

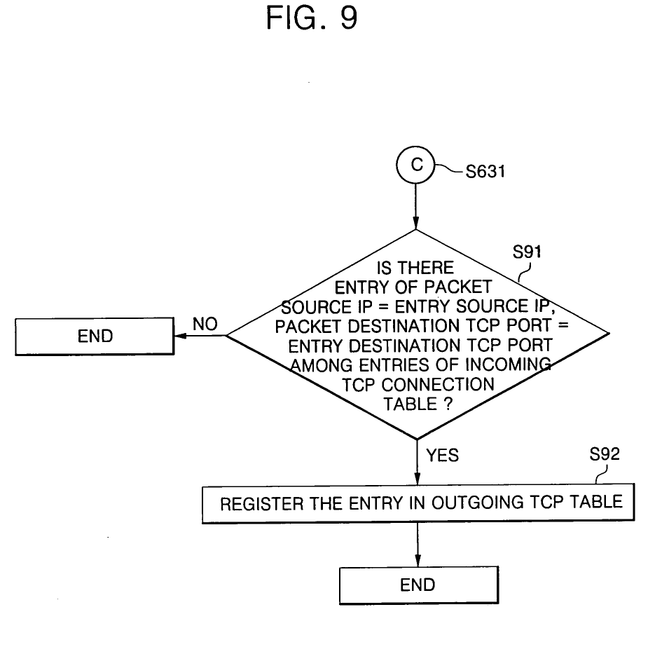

FIG. 9 is a flowchart of a method of processing an outgoing TCP SYN packet.

When traffic detected by the malicious code detection apparatus 20 is an outgoing TCP SYN packet, information on the corresponding packet is compared with each entry registered in the incoming TCP connection table (S91). Comparison items at this time are a source IP address of the SYN packet and a destination IP address of the incoming TCP connection table entry, and both a destination TCP port number of the SYN packet and a destination TCP port number of the TCP connection table entry.

Since the case where two comparison items are the same is the case where the traffic data registered as the incoming traffic is identical to the outgoing traffic, information on the SYN packet is registered in the outgoing connection table (S92).

The source IP address, the destination IP address, the source TCP port and the destination TCP port of the outgoing connection table entry are registered with information included in the TCP header of the SYN packet as is, and the data packet storage space is copied as is from contents of the data packet storage space of the incoming TCP connection table entry determined to include the same traffic.

The entry registration time is registered when the TCP SYN packet is registered.

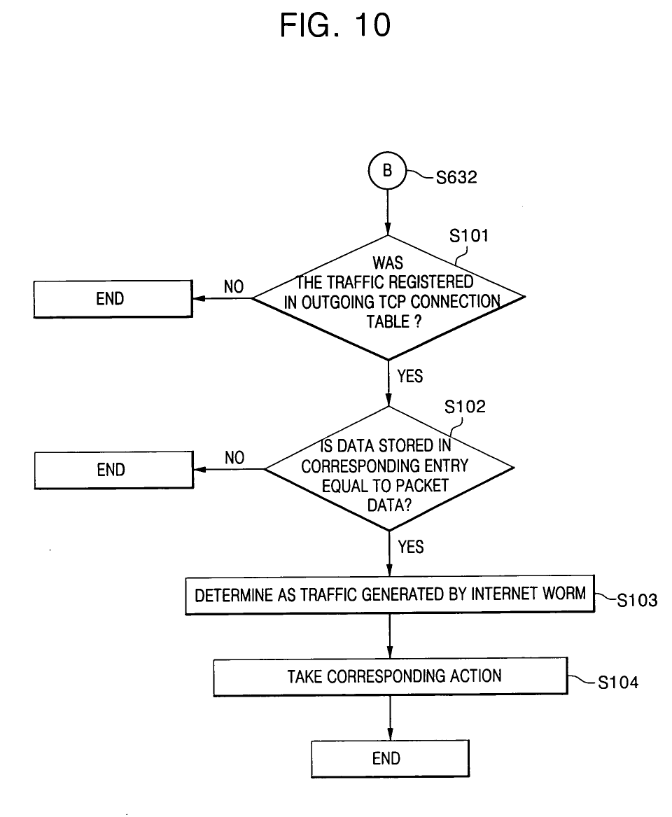

FIG. 10 is a flowchart of a method of processing an outgoing TCP data packet.

The outgoing TCP data packet refers to all packets that are not SYN packets among the outgoing TCP packets. When the malicious code detection apparatus 20 in accordance with an embodiment of the present invention detects an outgoing TCP data packet, a header of the data packet is compared with the source IP address, the destination IP address, the source TCP port number and the destination TCP port number of each entry of the outgoing TCP connection table to find an entry in which all of its items are matched (S101).

When an entry exists that satisfies the above condition, the contents of the data packet are compared with contents of the data packet stored in the data storage space of the corresponding entry (S102). When an identical packet among them is found, the outgoing TCP packet is determined to be a packet generated by an Internet worm (S103). The detection apparatus that has detected the Internet worm warns a manager that Internet worm traffic has been found and the outgoing TCP traffic generating the corresponding source IP address is reported to a previously designated information center, or takes a corresponding measure such as interception of the corresponding packet (S104).

Entries of each incoming and outgoing TCP data tables are removed from the corresponding table after the passage of a predetermined time period (ENTRY_TIMEOUT) from the registered time. Making allowance for rapid re-propagation delay time of the worm traffic is based on a determination that the entry after the passage of a predetermined time period from its registration time is not to be considered to be worm traffic.

By reducing the number of entries of each table, it is possible to overcome disadvantages such as entries in each table being increased, searching and processing times being lengthened so that the entire system is loaded.

The data storage space of the number of MAX_DATA_PACKETs included in two tables used in the detection apparatus stores pure entire data of the data packet, and a target of comparison in the comparison and search step also becomes an entire string.

However, the comparison of entire data means that the storage and searching times can be delayed, and a method of using the TCP checksum can be employed to overcome the delay efficiently. The TCP checksum was described with reference to FIG. 4. A packet can be stored with a space of 4 bytes, and comparison and searching procedures are simplified.

The Internet worm detection method based on the TCP described above can also be expansively applied to a UDP.

A basic procedure is the same as the case of a TCP except that, in the case of the UDP, a general data packet is searched for instead of the SYN packet and a table entry is generated without a packet that clearly requests a connection when constructing incoming/outgoing UDP connection tables.

When a data packet is received, if a data packet having the same source IP and destination IP and the same source UDP port and destination UDP port number is not received within a previous UDP session timeout time, the data packet operates as a TCP SYN packet so that it is possible to generate a table entry and should be stored as the first data packet simultaneously.

A person skilled in the art can devise a UDP processing procedure with ease using a timer such as a UDP session timeout described above, and infer a malicious code detection method and system based on the UDP with ease from the present invention based on the TCP.

In accordance with the present invention, unknown Internet worms can be detected by detecting the worms using only packets on the network without using a matching technique that uses the known pattern DB unlike existing anti-virus products, so that an erroneous warning is minimized and the Internet worms can be effectively detected. Since the detection is performed with respect to an outgoing packet, the consumption of all of the Internet network resources by the corresponding network can be prevented.

What is claimed is:

1. A method comprising:
registering information on an incoming TCP connection setup packet to an internal network and storing contents of a TCP data packet for the registered connection;
storing data for the corresponding TCP connection upon a connection determined to request a traffic connection of the same feature as the incoming TCP traffic within a predetermined time during a TCP connection setup being directed to an external network; and
determining a data packet to be malicious code upon a determination that the data packet of the outgoing TCP traffic is the same as the registered incoming TCP traffic data packet.

2. The method according to claim 1, wherein the incoming TCP traffic is stored in an incoming TCP connection table and the outgoing TCP traffic is stored in an outgoing TCP connection table.

3. The method according to claim 2, wherein the incoming TCP connection table comprises at least one entry including a source IP address, a destination IP address, a source TCP port number, a destination TCP port number, an entry registration time, and at least one data packet storage space.

4. The method according claim 2, wherein the outgoing TCP connection table comprises at least one entry including a source IP address, a destination IP address, a source TCP port number, a destination TCP port number, an entry registration time, and at least one data packet storage space.

5. The method according to claim 2, wherein registering information on an incoming TCP connection setup packet to an internal network and storing contents of a TCP data packet for the registered connection comprises registering the corresponding traffic with the incoming TCP connection data upon the corresponding packet not being registered in the incoming TCP connection data and the incoming traffic being a TCP SYN packet.

6. The method according to claim 5, wherein:
information on a source IP address, a destination IP address, a source TCP port, and a destination TCP port among header information of the incoming traffic TCP SYN packet is registered in the same item of the incoming TCP connection table;
an entry registration time is the time when the TCP SYN packet is registered; and
no data is registered in a data storage space of the incoming TCP connection table.

7. The method according to claim 2, wherein registering information on an incoming TCP connection setup packet to an internal network and storing contents of a TCP data packet for the registered connection further comprises:
comparing header information of the corresponding packet with the same item of each entry of the incoming TCP connection table and determining whether the corresponding traffic is registered in the incoming TCP connection table upon the incoming traffic being a TCP data packet; and
registering pure data information of the incoming TCP data packet in a data packet field of the corresponding entry upon an entry identical to the incoming TCP data packet being found as a result of the determination.

8. The method according to claim 7, wherein the data packet field comprises at least one storage space having a maximum value that is changeable by an operator.

9. The method according to claim 7, wherein comparing header information of the corresponding packet with the same item of each entry of the incoming TCP connection table and determining whether the corresponding traffic is registered in the incoming TCP connection table upon the incoming traffic being a TCP data packet comprises: comparing information on a source IP address, a destination IP address, a source TCP port, and a destination TCP port, and determining the information on the header of the incoming TCP data packet and the information on the incoming TCP connection table to be identical only when all of the comparison items are the same.

10. The method according to claim 10, wherein storing data for the corresponding TCP connection upon a connection determined to request a traffic connection of the same feature as the incoming TCP traffic within a predetermined time during a TCP connection setup being directed to an external network comprises registering information on the TCP SYN packet in an outgoing connection table upon information on the corresponding packet being compared with each entry registered in the incoming TCP connection table and an entry including the same information and the outgoing traffic being a TCP SYN packet.

11. The method according to claim 2, wherein determining that TCP SYN packet information and TCP connection table entry information are the same traffic comprises: determining that a source IP address of the TCP SYN packet and a destination IP address of the incoming TCP connection table entry are the same, and a destination TCP port number of the TCP SYN packet and a destination TCP port number of the TCP connection table entry are the same.

12. The method according to claim 2, wherein storing data for the corresponding TCP connection upon a connection determined to request a traffic connection of the same feature as the incoming TCP traffic within a predetermined time during a TCP connection setup being directed to an external network further comprises:
comparing a header of the corresponding packet and each entry information of the outgoing TCP connection table upon the outgoing traffic being a TCP data packet;
comparing contents of pure data of the outgoing TCP data packet with contents of a data packet stored in a data storage space of the corresponding entry upon a determination that entry information is the same traffic as the outgoing TCP data packet; and
determining the outgoing TCP traffic to be generated by a malicious code upon a determination that the two data are identical as a result of the packet comparison.

13. The method according to claim 2, wherein each entry of the incoming TCP table or the incoming TCP table is deleted from the corresponding table after the passage of a predetermined time period from an entry registration time.

14. The method according to claim 3, wherein information stored in the data packet storage space comprises a checksum value of transmitted pure data.

15. The method according to claim 4, wherein information stored in the data packet storage space comprises a checksum value of transmitted pure data.

16. A method comprising:
registering an incoming UDP connection to an internal network and storing contents of a UDP data packet for the registered connection;
determining that an internal host, connected to outside by a connection request received from outside, has requested a connection to the same destination UDP port within a predetermined time, among the UDP connections directed to an external network from the internal network and an outgoing UDP traffic registration to store data for the corresponding UDP connection; and
determining that a packet is malicious code upon a determination that the outgoing UDP connection data packet and the packet registered with the incoming connection data are the same.

17. The method according to claim 16, wherein registering and storing UDP data comprises generating a UDP table entry and storing the corresponding data packet upon the same data packet having not been received within a session timeout time period of a previous UDP session for a specific data packet.

18. An apparatus comprising:
a database including an outgoing TCP connection table adapted to register incoming TCP packet setup packet information to an internal network, and to store data for the corresponding TCP connection upon an incoming TCP connection table storing contents of a TCP data packet for the registered connection and a TCP connection directed to an external network from the internal network receiving a connection request from outside and an internal host connected to the outside requesting a connection to the same destination TCP port within a predetermined time period; and
a controller connected to the incoming and outgoing TCP connection tables and adapted to register, compare and store data and to determine a data packet to be malicious code upon a data packet of the outgoing TCP traffic being the same as the registered incoming TCP traffic data packet.

19. The apparatus according to claim 18, wherein the apparatus is arranged in a bottleneck between the internal network and an external Internet network.
